(19) United States
(12) Patent Application Publication
(10) Pub. No.: US 2006/0089898 A1
(43) Pub. Date: Apr. 27, 2006

(54) Intra-day matching system and method

(76) Inventors: Bryan T. Durkin, Orland Park, IL (US); Thomas G. McCabe, Chicago, IL (US); James G. Bennett, Glen Ellyn, IL (US); Dennis M. Collins, Downers Grove, IL (US); Melissa H. Kemp, Barrington Lake, IL (US); Anita Olivia Lynch, Chicago, IL (US); Jacqueline B. Owens, South Holland, IL (US); Laurence M. Ratner, Deerfield, IL (US); Mary Beth E. Rooney, Park Ridge, IL (US)

Correspondence Address: MCCRACKEN & FRANK LLP, 200 W. ADAMS STREET, SUITE 2150, CHICAGO, IL, 60606, US

(21) Appl. No.: 11/236,995

(22) Filed: Sep. 28, 2005

Related U.S. Application Data
(60) Provisional application No. 60/621,781, filed on Oct. 25, 2004.
(60) Provisional application No. 60/622,890, filed on Oct. 28, 2004.

(51) Int. Cl. G06Q 40/00

(52) U.S. Cl. 705/37

(57) ABSTRACT

A system and method that provides intra-day confirmation of non-anonymous trade transactions made at an exchange includes the entry into a computer system of first data relative to the trade transaction on behalf of one party to the trade transaction, wherein the first data include a code identifying an opposing party to the transaction. A message is sent to the designated opposing party prior to submitting the trade transaction for matching prior to end-of-day clearing. The trade transaction is matched to second data relative to the trade transaction entered into the system based on identity between certain elements of the first data and the second data, and a confirmation is sent to at least one of the parties to the trade transaction.

### CROSS REFERENCE TO RELATED APPLICATIONS

This application claims the benefit of U.S. Provisional Application No. 60/621,781 filed Oct. 25, 2004, entitled “Trade Confirmation System.”

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

This invention relates to a confirmation system to confirm trade transactions made in an open outcry or similar market in near real time. More particularly, this invention relates to a communication and an intra-day matching system to minimize unmatched incorrectly entered trade transactions.

2. Description of the Background of the Invention

In a typical exchange setting, traders will make trade transactions for a wide variety of tradable products using face-to-face communication techniques. A trade transaction can involve stocks, bonds, financial instruments, futures, options, cash, and other similar instruments. The concept of a financial instrument in today's marketplace can include a wide variety of items that have extended far beyond what was originally considered a financial instrument. This includes contracts for the future delivery of agricultural and other commodities, including metals, oils, and the like. Also, the financial instrument can include derivative instruments that include options of all types and instruments that are based on a basket of other instruments such as options based on the Dow Jones Industrial Average, currency exchange baskets and the like. A trade transaction can include the buying and selling of any of the above financial instruments and similar instruments, as well as similar rights and obligations.

In an open outcry pit, trading involves the use of hand signals where two traders each indicate their willingness to make a trade transaction at a particular price point. Currently, these trade transactions are recorded on paper slips that are then passed to a runner or clerk for entry into the computer system of the trader, broker, and/or clearing firm. The data from the trader's system are then passed on to the computer system of the exchange for clearing. With both sides making manual entries, both on the paper slip and into their respective computer systems, there is an opportunity to have one side of the trade transaction entered incorrectly.

Exchanges have procedures at the close of a trading day to reconcile these incorrectly entered trade transactions and most errors are corrected. However, this procedure can be time consuming and generally a trader will not know until after the exchange has closed for the day if all the trade transactions they thought were made that day were in fact successfully made and entered into the system for clearing. The existing computer systems do not provide real time or even reasonably contemporaneous feedback to the traders about the matching or acceptance of trade transaction data that have been entered into these prior systems. As a result, a trader can later discover that a trade transaction the trader thought was successfully concluded was not matched and as a result the trader has exposure the trader did not expect. By the time the error is caught, there is often no way to correct the error that would place traders on both sides of the trade in the position where they thought they were when the trade transaction was actually made. These unmatched trade transactions are known as “out trades” and can be quite costly for the traders involved. The resolution of out trades also causes disruption to the orderly process of running an exchange.

In addition, many trade transactions made today are a part of a strategy of trade transactions designed to minimize risk to the trader by hedging the trade transaction in some fashion against a second and/or third instrument, such that if a single part of the trade strategy is not successfully made due to a data entry or similar clerical error, the trader will often be exposed to considerable risk, many times without knowing that the trader has any exposure.

The use of computers located on or near the trading floor to enter the trade transactions quickly has reduced the number of out trades that are the result of keying errors or errors in transcribing the paper trading slips. These current systems do not provide feedback to the trader or broker relative to the acceptance of the trade transaction data that have been entered. A broker or trader still will not know until the end-of-session or end-of-day processing if all trade transactions that the trader thought were made using these computer systems were in fact correctly entered and matched for clearing.

Electronic trading exchanges that are in use by some exchanges do match trade transactions automatically in real time. The matching of trade transactions in an electronic trading host is done based on a match of the price and quantity or by other similar matching algorithms. These electronic trading matching hosts do not match based on the identity of one or both participants in the trade transaction and in fact most of the electronic trade matching is done anonymously.

If an exchange is able to send trade transactions in matched and locked pairs to the clearing center, the cost to the exchange for processing the trade transactions made that day will be reduced. This is because the clearing center will only need to record a previously fully matched trade transaction. There will be no need to process these trade transactions through the clearing centers' matching algorithms thereby saving time and computing power. In addition, the exchange, and possibly others, will be able to have access to the intra-day matched trade transactions to monitor activity levels, to look for risk management concerns, and to audit activity for abuse of exchange rules and procedures. Furthermore, the use of such a system will enable traders to meet performance standards, such as the entry of a significant percentage of all trade transactions within a pre-defined time period after the trade transaction has been made. Also, an intra-day matching and communication system will allow a trader to monitor the trader's activity throughout the day and have some understanding of the risk of the trader's current position in the market, including the number of trade transactions that have been made but are as yet unmatched.

### SUMMARY OF THE INVENTION

One embodiment of the present invention relates to a system for confirming prior to clearing a non-anonymous trade transaction made at an exchange. This system includes a data entry circuit that enables the entry into a computer system of first data relative to the trade transaction on behalf of one party to the trade transaction, wherein the first data includes an identity of the item that is the subject of the trade transaction, a price, a quantity and a code identifying an opposing party to the transaction. The system also includes a messaging circuit that sends a message relative to the trade transaction to the opposing party prior to submission of the trade transaction to a matching circuit that matches the trade transaction to second data relative to the trade transaction entered into the system based on identity between certain elements of the first data and the second data. Lastly, the system includes a confirmation circuit that sends a message confirming the match to one of the parties.

A further embodiment of the present invention relates to a method for confirming prior to clearing a non-anonymous trade transaction made at an exchange. The method comprises the steps of entering into a computer system of first data relative to the trade transaction on behalf of one party to the trade transaction, wherein the first data include an identity of the item that is the subject of the trade transaction, a price, a quantity and a code identifying an opposing party to the transaction and sending a message relative to the trade transaction to the opposing party. The method also includes the steps of matching the trade transaction to second data relative to the trade transaction entered into the system based on identity between certain elements of the first data and the second data, and sending a confirmation of the match to one of the parties.

Other aspects and advantages of the present invention will become apparent upon consideration of the following detailed description.

### BRIEF DESCRIPTION OF THE DRAWINGS

FIG. 1 an overview flow diagram of one embodiment of the system of the present invention that shows the relation of the system to other systems such as a clearing system;

FIG. 2 is a flow diagram of an additional embodiment of the present invention;

FIG. 3 is a table showing a state of a trade transaction at various times during an embodiment of the present invention;

FIG. 4 is a flow diagram of a further embodiment of the present invention;

FIG. 5 is a flow diagram of an example of another embodiment of the present invention;

FIG. 6 is a flow diagram of an example of a further embodiment of the present invention;

FIG. 7 is a flow diagram of a still further embodiment of the present invention;

FIG. 8 is a flow diagram of yet another embodiment of the present invention;

FIG. 9 is a flow diagram of still another embodiment of the present invention; and

FIG. 10 is a flow diagram that illustrates an aspect of one embodiment of the present invention.

### DETAILED DESCRIPTION OF THE PREFERRED EMBODIMENTS

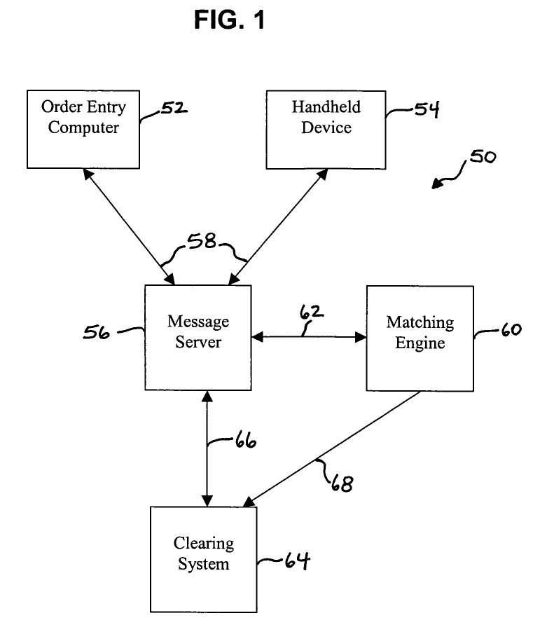

FIG. 1 shows an overview of the architecture of one embodiment of a trading system 50 of the present invention. The trading system 50 is a non-anonymous, that is, face-to-face, trading environment such as an open outcry pit that includes a number of electronic input devices. These electronic input devices include as examples, an order/trade entry computer 52, and a handheld device 54. The order/trade entry computer 52 can be any type of computer typically used in an exchange environment including computers located near the trading floor or pit, custom programmed computers using an API provided by the exchange or computers running software used by the exchange to record and enter orders into the exchange's computer order system. There can be different input devices of the same class of input devices as well as input devices from different classes connected to the trading system 50 at the same time. The trading system includes a message server 56 that acts to coordinate and route messages between the various input devices and other elements of the trading system 50. The messages between the message server 56 and the input devices 52 and 54 pass over a two way interface 58. The interface 58 can be any conventional interconnection between elements of a system, such as Ethernet, the Internet, intranet, wide area network (WAN), wireless connection, or other similar connection. The interface 58 may optionally include a dedicated server to facilitate communication to and from a particular class of input devices, such as a server to facilitate the use of the handheld device 54.

In one embodiment, the communication among the elements will be over a networking and messaging solution known as WebSphere MQ from IBM. The message server 56 can be any conventional computer that will accommodate a large number of messages and data input streams. One such solution for the message server 56 is a J2EE Java based system deployed on a BEA WebLogic server. A number of queues can be set up such as one for inbound messages and one to communicate outbound messages. A matching engine 60 will use similar technology. The message and data format will conform to the MQ API and data will be in a language format, such as TREX, FIXML or other similar data formats and structures. These data formats are designed to facilitate intercommunication among exchanges, and their users, such as brokerage firms.

In some exchange scenarios, the order/trade entry computer 52 will be a computer that is located immediately adjacent to a trading pit or floor. The order/trade entry computer 52 may be directly connected to the network that runs order entry software for the exchange or as noted above can be routed through an intermediary server or other connection. Traders or brokers can enter trade transaction data directly into the order/trade entry computer 52 instead of writing the information on a trading slip and handing the slip to a clerk or runner for later data entry. Most exchanges also will have some form of the customized order/trade entry computer 52. These customized order/trade entry computers 52 can be computers running programs developed by the exchange or developed by members of the exchange using an API made available by the exchange. The order/trade entry computers 52 are the traditional method for entry of trade transaction data into the exchange system and may include proprietary systems used by the member firm's back office personnel to enter the trade transaction data from the paper trading slips. Alternatively, order/trade entry computer 52 can be used by the traders themselves through browser based or other computer terminals located near the trading floor if the traders do not have access to the their own order/trade entry computer 52 or the handheld device 54.

In addition, some exchanges now also utilize the handheld device 54 that enables traders to quickly enter the basic details of a trade transaction without leaving the trading floor or pit. The handheld device 54 is programmed to enable traders to enter key information about a trade transaction, such as the nature of the financial instrument traded, i.e., September 2005 Corn, the type of trade transaction, i.e., buy or sell, the price, the quantity, and an identifier of the other party to the trade transaction, often by acronym or other identifier. This key information can be quickly entered using shortcuts built into some of the hand held devices 54. The handheld device 54 is wireless and communicates with the exchange network through a conventional wireless link.

The message server 56 is in communication with the matching engine 60 located within the exchange through an interface 62. In one embodiment, the message server 56, and the matching engine 60 may be separate modules running within the same computer. In this case, the interface 62 is internal to the computer. For embodiments where the message server 56, and the matching engine 60 are in different computers, the interface 62 also provides two way communications between the message server 56 and the matching engine 60. Interface 62 typically will be a high speed WAN type or similar connection capable of high amounts of data throughput and permits high speed two-way messaging between the message server 56 and the matching engine 60. The message server 56 also is in communication with a clearing system 64 though an interface 66. This interface 66 is a conventional communication system well known to those skilled in the art. The interface 66 provides two way communications between the message server 56 and the clearing system 64. In addition, the matching engine 60 may optionally have a direct communication link 68 to the clearing system 64. In this direct connection embodiment, the matching engine 60 will only notify the clearing system 64 of trade transactions that are matched by the matching engine 60. In other embodiments, all communication from the matching engine 60 to and from the clearing system 64 will pass through the message server 56.

In one aspect of an embodiment of the present invention, the message server 56 validates the key information for trade transaction data that have been entered into the system 50 either directly or though a subsystem. For instance, the data identifying the parties must match party identifiers contained within the exchange databases. If key information is missing or entered using an invalid code the message server 56 will send the entering party an error message identifying the missing or incorrect data. This optional validation step only will make sure that the data are valid. Valid, but incorrect data, will still be processed. This incorrect data will possibly be corrected by one of the parties during the periods when the data, including key information, can be changed.

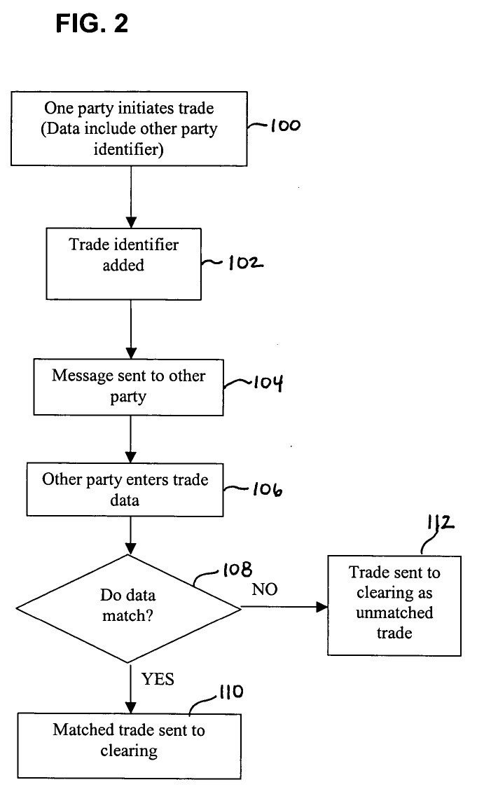

With reference to FIG. 2, in one embodiment a block 100 records a trade transaction that an initiating party has entered into one of the various input devices, such as the handheld device 54. The trade transaction data that are recorded should include at least the key information described above. The trade transaction data also can include other non-key information but for certain embodiments of the present invention the key information is the minimum information that must be present to fully identify the trade transaction to the system 50. For other embodiments, it may be possible to include less than all key information and still be able to successfully match the trade transaction prior to clearing. Control now passes to a block 102 that then adds a trade identifier to the trade transaction data that have been recorded in the system 50. The trade identifier is a unique identifier of that trade transaction data so the trade transaction data can be tracked by the system 50.

At this point, the trade transaction data with the trade identifier are then sent to the message server 56 that passes control to a block 104 that sends a message to the other or opposing party or parties to the trade transaction, as identified by the key information data recorded by the block 100. This message will usually include all the key information relative to the trade transaction and may include other information referred to above. Control passes to a block 106 that records information about the trade transaction entered by the other or opposing party. In certain embodiments, this information can be an acceptance of the trade transaction message generated by the block 104. In other embodiments, this information also can be an independent recording of the trade transaction data by the other party. This can occur when parties on both sides of the trade transaction record the trade transaction data at roughly the same time. Based on the rules and business practices at certain exchanges, the system may be set up in certain embodiments to require that the seller always enter and record the trade transaction data. In this particular embodiment, the seller will not be able to accept trade transaction data that had been previously entered by the buyer. In other embodiments, the first person, either buyer or seller, to enter the trade transaction data becomes the initiating party and the other party can accept or link to the previously entered trade transaction data. Also, as discussed below, the acceptance of the trade transaction can be automated, such that if there is a match to trade transaction data entered by the opposing party in that party's own input device, the device or computer can either suggest acceptance of a particular trade transaction or actually automatically link the incoming trade transaction data to previously entered trade transaction data in memory of the device without further interaction by the opposing party. The auto-linking feature is an option that the trader can set in that party's respective input device. Typically, the auto-linking feature will only automatically link trade transaction data that are a perfect match, that is, trade transaction data where all the key information matches.

At this point, the message server 56 passes the linked trade transaction data from the buyer and seller to the matching engine 60. Control then passes to a block 108 that determines if the trade transaction data are a match based on various trade algorithms and if the trade transaction data match the system 50 will branch via the YES branch to a block 110 that sends the intra-day matched trade transaction to the clearing system 64. In this instance, the clearing system will not have to match the trade transactions and can perform the remaining clearing functions on the transaction without having to attempt to match the trade transaction data to other trade transaction data. If the trade transaction data do not match, the system will branch via the NO branch to a block 112 that sends both trade transactions to the clearing system 64 as unmatched trade transaction data. In this instance, the clearing system 64 will attempt to match the trade transaction data to other trade transaction data in a conventional fashion. Also, in other embodiments as discussed below, the matched and unmatched transactions can be held by the matching engine 60 for predetermined periods during the trading day to facilitate later possible intra-day matches prior to being sent to the clearing system 64. Also, in some embodiments, the trade transaction data may only partly match. One such situation is where there are multiple parties to one side of the trade transaction and each party only accepts their portion of the trade transaction. In another example, the opposing party may only accept a portion of the trade transaction. In this example, the initiator may have incorrectly keyed in 50 contracts where the opposing party was buying 15 contracts. In this case the 15 contracts will be matched and the remaining 35 contracts will be ultimately sent to clearing as an unmatched trade transaction. The initiator will also be sent a message by the message server 56 that only a portion of the trade transaction was accepted.

As will be discussed more fully hereinafter, changes can be made to the key information prior to the trade transaction data being matched either by the matching engine 60 or by the clearing system 64. However, even after the trade transaction data are matched and the key information is locked, in some embodiments it is possible to enhance the trade transaction data with additional non-key information as is currently done by broker back office personnel. For instance, it is possible to add billing, and other similar information to the trade transaction data even after the trade transaction data have been matched. In addition, for some embodiments, the system 50 may allow a limited period of time after a trade transaction has been accepted or linked by the opposing party in the block 106 for either party to make changes to any data, including key information. If key information is changed, the message server 56 will notify all parties to the trade transaction that key information has been changed and remove the trade transaction from the linked state. Typically, this limited period of time will be short, but long enough to allow a trader to realize that an acceptance of a trade transaction or other data have been entered incorrectly and easily rectify the error without requiring complicated mismatch procedures. For instance, where a party enters a valid but incorrect identifier for the opposing party and where that incorrect party inadvertently links to the trade transaction, either party for a short period of time can cancel the trade transaction or at least cancel the acceptance or link to the trade transaction. In addition, the initiating party can make a change to the opposing party identifier so that the proper opposing party is identified in the trade transaction data and that the proper opposing party can thereafter accept or link to the trade transaction. Because the exchange can monitor the intra-day activity, the exchange can audit these changes after linking to be sure that there is no abuse of the exchange rules and regulations.

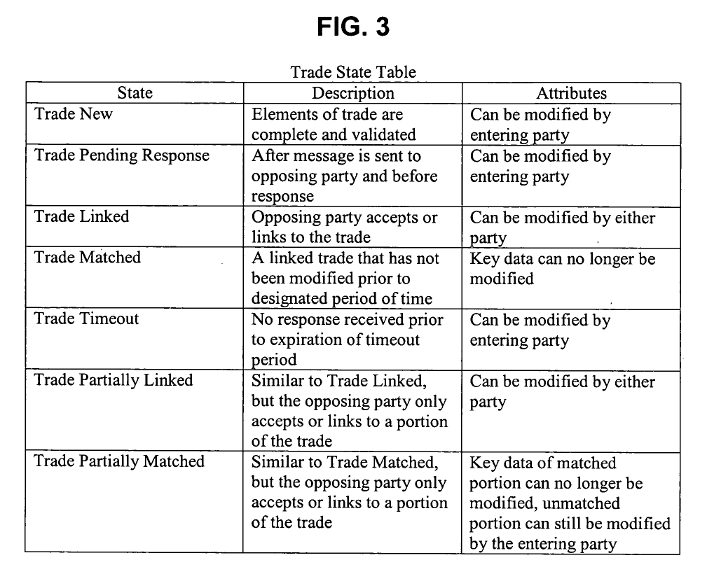

In one embodiment of the system 50, the trader can make modifications or corrections to trade transaction data that they have entered into the system 50 or trade transaction data that have been entered on their behalf into the system 50. However, the ability to make changes is dependent on the state of the trade transaction in the system 50. FIG. 3 shows a state table showing the states that a trade transaction may pass through as the trade transaction proceeds through the system 50. In one embodiment, the trade transaction can be made up of one or more TREX transactions. When new trade transaction data are recorded by the appropriate input device, the state of the trade transaction data is Trade New. When the trade transaction data in the Trade New state are communicated to the message server 56, the trade transaction data state will change from the Trade New state to a Trade Pending Response state. During the time that the trade transaction data are in either of the Trade New state or the Trade Pending Response state, the entering party can go into the trade transaction data and make changes to any field in the trade transaction data, including key information. This enables an entering party to correct errors made while entering the trade transaction into the particular computer device. While the trade transaction data are in either of these states, the trade transaction data can also be completely deleted. Once the opposing party has accepted or has linked to the trade transaction data, the trade transaction data move to the Trade Linked state. During the time that the trade transaction data are in the Trade Linked state, either party to the trade transaction can make changes to any of the data fields of the side of the trade transaction that party entered, including key information fields. If a change is made to a key information field, the state of the trade transaction is changed from the Trade Linked state to the Trade Pending Response state and the message server 56 sends a message to the other party breaking the link. The former opposing side of the trade transaction is now in a Trade Pending Response state.

A particular trade transaction will remain in the Trade Linked state for only a limited predetermined period of time. Once this time period has elapsed without any changes made to the trade transaction data, the state then changes to a Trade Matched state. In the Trade Matched state, the trade transaction data is fixed and the key information can no longer be either modified or deleted by either party. However, non-key information can still be modified or enhanced as is currently done by many exchanges and clearing systems.

In the event that the trade transaction data are partially matched the trade transaction data will go to the Trade Partially Linked state. In this state, the portion of the trade transaction data that has been linked is treated in the same fashion as the Trade Linked state above. In addition, the unmatched portion of the trade transaction data can still be changed or deleted. After the appropriate period of time has elapsed, the trade transaction data will move to the Trade Partly Matched state. The portion of the trade transaction data that have been matched is treated as a matched trade transaction so that the key information of that portion of the trade transaction data can no longer be changed or modified. The unmatched portion of the trade transaction is treated as if it is an unmatched trade transaction. This portion can be changed or even deleted. The remaining state, the Trade Timeout, allows the entering party to make modifications to the transaction or to delete the transaction entirely. It will be appreciated that because one objective of the system and method of the present invention is intra-trading day confirmation certainty, it should not be possible to delete or change key information for a matched transaction unless it has been determined that the match was made in error and both parties agree to an unmatch process. Non-key information, i.e., information that is not core to the nature of the transaction between the two parties, can be modified, added or enhanced as can now be done in conventional systems. However, in the embodiment that uses the Trade Linked state, there will be a limited period of time after a trade transaction has been accepted or linked for either party to correct errors, including errors in key information fields.

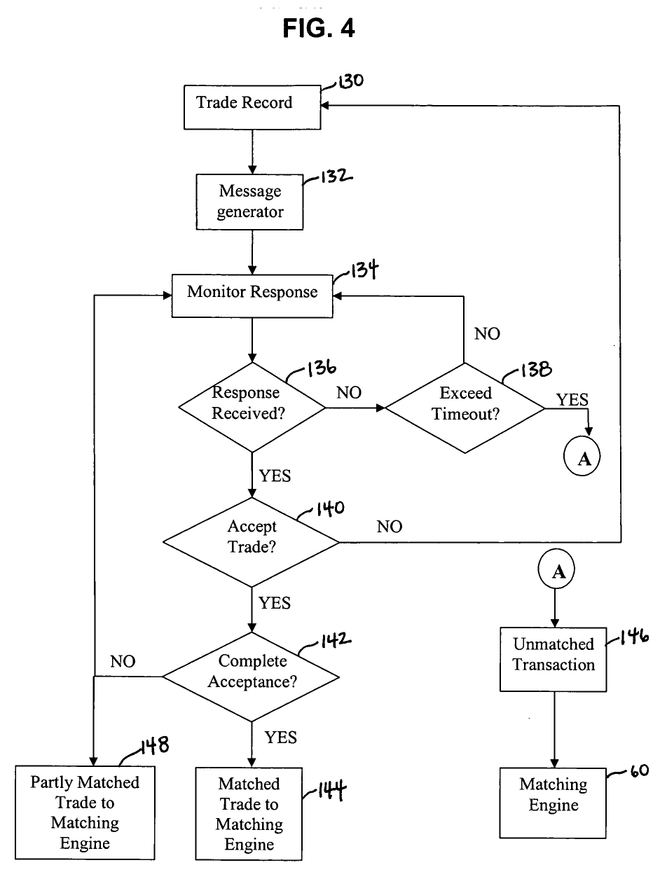

FIG. 4 shows the steps that the message server 56 takes as it receives trade transaction data. A block 130 records trade transaction data entered by one party to the trade transaction. As noted previously, the trade transaction data can be entered into the system 50 using any of the appropriate input devices. If the trade transaction data recorded by the block 130 includes information relative to the identity of the opposing party, a block 132 sends a message to the computer of the opposing party. In certain embodiments, traders may be able to use multiple input devices to send and receive trade transaction information and data. These devices can be separate hand held devices 54 that are each used to make trades and to receive information relative to a particular product. Alternatively, the trader can use the order/trade entry computer 52 and also use the handheld device 54. Each input device will be registered by the system 50 so that the message server 56 knows which device to send the appropriate messages. For instance, a broker may be trading in multiple agricultural pits at the same time and may have one handheld device 54 for trade transactions that relate to Corn and another handheld device 54 that relates to trade transactions for Soybeans. It is possible that the devices could be specified to receive trade transactions that relate only to a particular contract, such as September 2005 Corn. Further, a single handheld device 54 can be programmed to accept messages and enter and send data relative to multiple instruments. The message server 56 can be programmed to recognize the appropriate device for the broker based on the identity of the broker or trader and the product being traded.

At this point, control passes to a block 134 that monitors for a response from the opposing party. This monitoring is done by a loop that passes through a block 136 that checks to see if a response has been received from the opposing party identified in the trade transaction data. If no response has been received, control will pass via the NO branch to a block 138 that checks to determine if the elapsed time since the trade transaction data were recorded has exceed a preset timeout period. In some embodiments, the timeout period may be set to a relatively short period of time, such as 30 minutes. This period will provide the opposing party sufficient time to catch up if there has been a high level of activity and accept, link to or enter trade transaction data for trade transactions that have been made. A short timeout period will also encourage traders and brokers to promptly enter trade transaction data in a timely fashion so that there are a minimum number of trade transactions where the trade transaction data do not match. Also, by entering data quickly, the trade transaction can be confirmed in near real time so that the trader knows that the trade transaction has been confirmed and the risk of an out trade has been minimized, at least for that trade transaction. If the timeout period has not been exceeded, control will pass back to the block 134 that begins the monitoring loop anew. If the block 136 determines that a response has been received relative to the trade transaction data recorded in the block 130, control will pass via the YES branch to a block 140 that determines the nature of the response. If the response is an acceptance of the trade transaction, the block will branch via the YES branch to a block 142 that determines the nature of the acceptance. If the block 142 determines that the acceptance is a complete acceptance of the trade transaction data recorded in the block 130, control passes to a block 144 that sends the trade transaction data on to the matching engine 60 to be matched based on an intra-day matching algorithm to be more fully discussed hereinafter. Alternatively, the message server 56 can perform limited matching for perfect matches that have been accepted by the other party and these matched trade transactions can be sent directly by the message server 56 to the clearing system 64.

If the block 138 determines that the timeout period has been exceeded, control will pass via the YES branch to a block 146 that identifies the trade transaction as an unmatched trade transaction and sends the unmatched trade transaction to the matching engine 60. At some point during the day, the trade transaction data that remain as unmatched in the matching engine 60 will be forwarded on to the clearing system 64 for conventional end-of-day matching and balancing. If the block 140 determines that the response received is a rejection of the trade transaction, control will pass from the block 140 via the NO branch to the block 130. At this point the block 132 sends a message to the initiator indicating that the trade transaction was rejected. The trade transaction will go back to the block 134 that monitors for a further response. If no response is received during a new timeout period the block 138 will branch via the YES branch and the trade transaction will be marked by the block 146 as an unmatched trade transaction. Thereafter, the trade transaction data are sent on to the matching engine 60. In certain embodiments, if the rejected trade transaction data are not matched during the day, the rejected and still unmatched trade transaction data will also be forwarded on to the clearing system 64 for conventional end-of-day processing and matching. In other embodiments, the unmatched trade transaction data will be sent to clearing 64 prior to the end of the day.

If the block 142 determines that the acceptance is a partial acceptance of the trade transaction, control will pass via the NO branch to both the block 134 to continue to monitor for a response to the unaccepted portion of the trade transaction, and to a block 148 that sends the portion of the trade transaction that has been matched and accepted to the matching engine 60 as a linked pair of trade transaction data. One example is the trade transaction recorded in the block 130 has multiple opposing parties that each take a portion of the contracts the seller has to sell. Assume that the seller sells 20 contracts of September 2005 Corn and Buyer A buys 7 contracts and Buyer B buys 13 contracts. When Buyer A accepts the 7 contract trade transaction, that partial trade transaction will be sent to the matching engine 60 as a linked pair. If Buyer B later accepts the 13 contracts, then those 13 contracts will be ultimately sent on to the matching engine 60 as a linked pair. However, if Buyer B does not respond within the timeout period or at all, the 13 contracts sold to Buyer B will be considered as an unmatched trade transaction and will be sent to the matching engine 60 for a possible later intra-day match and ultimately on to the clearing system 64 for conventional end-of-day processing. Another example is where the initiator enters an incorrect number of contracts or instruments. In this case, the other party can accept the number they believe to be accurate and reject the remainder. The rejected remainder will be considered as unmatched and the seller will be so notified.

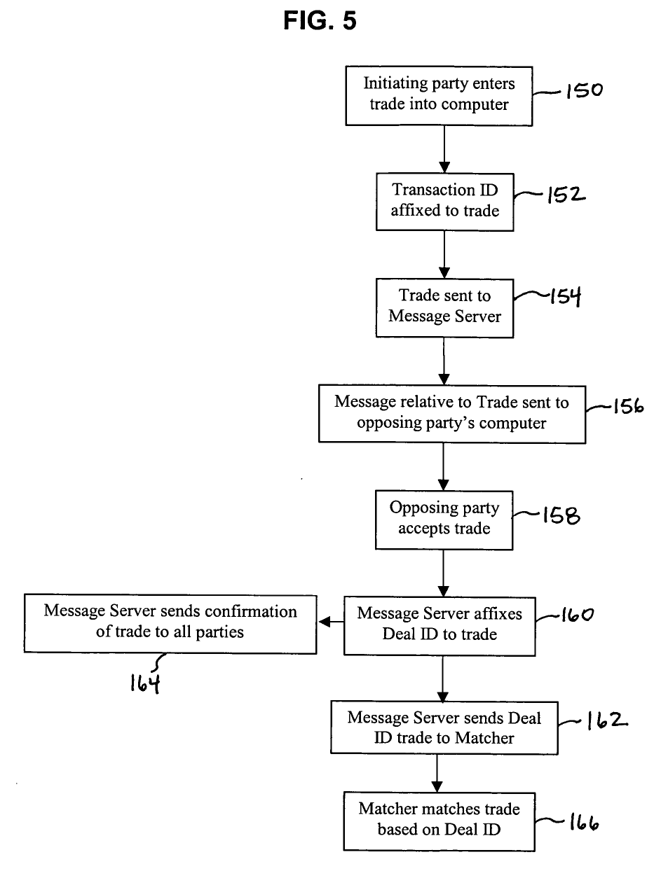

FIGS. 5 to 10 show examples of certain aspects of the system 50, including examples of opposing parties linking to trade transaction data, an example of a change to trade transaction data while in the link state and an example showing a match where there is no actual acceptance or linking.

FIG. 5 shows a block diagram of one embodiment of the system and method of the present invention. A block 150 records trade transaction data that an initiating party, such as a seller, enters into an input device, such as the handheld device 54. Control now passes to a block 152 that adds a Record ID to the trade transaction data recorded by the block 150. This Record ID is used to track the particular trade transaction data that have been entered by the initiating party. Control then passes to a block 154 that sends the trade transaction data along with the Record ID to the message server 56. At this point, a block 156 sends a message to the opposing party's computer, which can be any of the various input devices noted in FIG. 1. The opposing party receives the message and accepts the trade transaction. A block 158 in the message server 56 records the acceptance of the trade transaction and control will then pass to a block 160 that affixes a Deal ID to the trade transaction data and links the trade transaction. Following a predetermined link period, and if the trade transaction has not been modified by either party, a block 162 in the message server 56 sends the trade transaction data including the Deal ID and the identity of both the seller and the buyer to the matching engine 60. At the same time, the block 160 also passes control to a block 164 that sends a confirmation message to all parties to the trade transaction that the trade has been linked. Once the trade has been matched by the matching engine 60, a confirmation match message is sent to all parties. Control then passes from the block 162 to a block 166 in the matching engine 60 that matches the trade transaction data based on the Deal ID. All parties now are confident that the trade transaction has been properly recorded by the exchange and this trade transaction has been properly matched. A particular trader's input device, such as the handheld device 54, will have access to the intra-day matching data and the trader will know those trade transactions that the trader has made that day, including trade transactions that have been matched, and trade transactions that remain in an unmatched state. At this point, the matching engine 60 will pass the matched trade transaction data directly to the clearing system 64 for end-of-day processing or send a message to the message server 56 to instruct the message server to send the matched trade transaction to clearing 64.

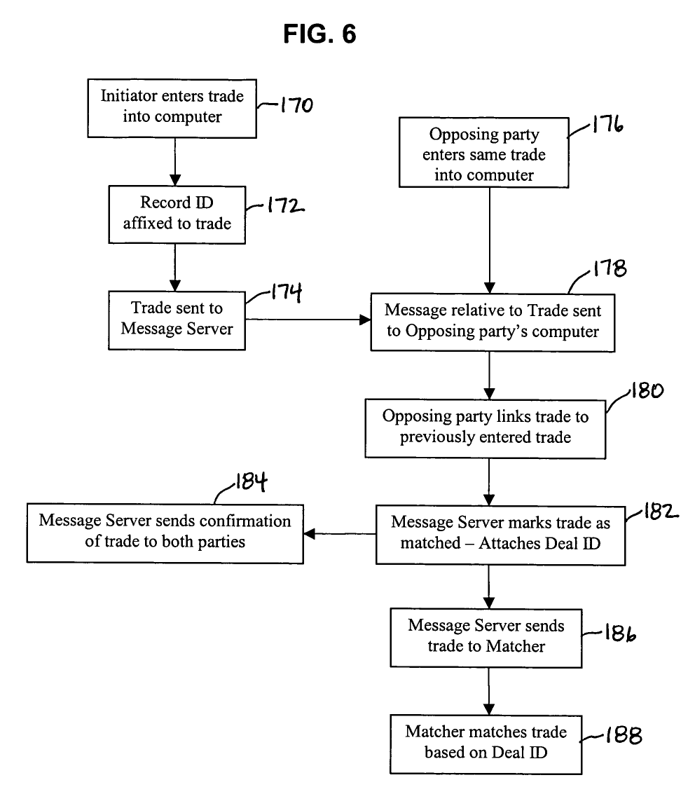

FIG. 6 shows another embodiment of the present invention. A block 170 records trade transaction data that an initiator, either a buyer or a seller, have entered into that party's computer input device. Control passes to a block 172 that affixes a Record ID to the trade transaction data, and control then passes to a block 174 that sends the trade transaction data on to the message server 56. At roughly the same time as the initiator has entered the trade transaction data into the initiator's computer, an opposing party also records the same trade transaction that is recorded in the system 50 by a block 176. The message server 56 passes control to a block 178 that sends an advisory message to the opposing party's computer relative to the trade transaction data recorded by the block 170. Control then passes to a block 180 that allows the opposing party to link the trade transaction data recorded by the block 170 to the trade transaction data that the block 176 has recorded based on the input from the opposing party. In an alternative embodiment, a trader may program the trader's computer or input device to automatically accept or link trade transaction data that are a perfect match, i.e., one where the key information of trade transaction data exactly match to trade transaction data that previously have been entered on that trader's computer. After the link has been made, control then passes to a block 182 that marks the trade transaction data recorded by the block 170 as linked. In addition, the message server 56 also affixes a Deal ID to the linked transactions. After the trade transaction data have been marked as linked by the block 182, control then passes to a block 184 that sends a confirming message that the trade transaction has been linked to both the buyer and the seller. Control also passes to a block 186 that sends the linked trade transaction data to the matching engine 60. At this point, the matching engine 60 in a block 188 matches the trade transaction data based on Deal ID.

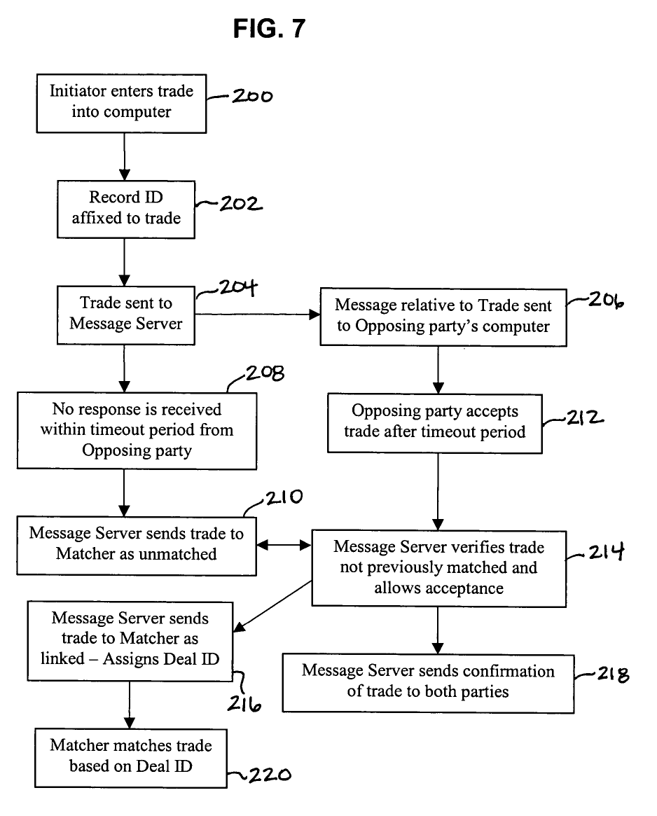

FIG. 7 shows another embodiment of the present invention that allows a party to accept a trade transaction even after the timeout period has expired. In this embodiment, care must be taken to avoid a race condition, i.e., a situation where two different systems compete to simultaneously match the trade transaction. Depending on the time taken after the timeout period has expired, it may be possible that the trade transactions will have been previously sent on to the clearing system 64 and that the clearing system 64 will be attempting to match the trade transactions. In certain embodiments, a party only will be able to link to a trade transaction that has passed beyond the timeout period, where the period beyond the timeout period is less than a predetermined second timeout period. In this case, a block 200 records the trade transaction data that have been entered relative to a trade transaction concluded by an initiating party. Control passes to a block 202 that affixes a Record ID to the transaction data. Control then passes to a block 204 that sends the trade transaction data to the message server 56. The message server 56 passes control to a block 206 that sends a message to an opposing party identified by the initiator as the other party to the trade transaction. In this instance, the opposing party does not accept the trade transaction within the prescribed initial timeout period. When the initial timeout period elapses, the message server 56 will pass control to a block 208 that determines that the initial timeout period has expired for that trade transaction. At this point, control will pass to a block 210 that sends the trade transaction data to the matching engine 60 as an unmatched trade transaction.

Sometime after the expiration of the initial timeout period, but before the expiration of the second timeout period as discussed above, a block 212 records that the opposing party accepts the previously notified trade transaction using the opposing party's input device. Control will then pass to a block 214 that queries the message server 56 to determine the current status of the trade transaction the buyer has accepted. Because the trade transaction has initially timed out, the block 214 determines that the trade transaction is still in the unmatched state and the block 214 accepts the link from the opposing party to the trade transaction data entered by the initiator. Control will then pass to a block 216 that marks the previously unmatched trade transaction data as linked, affixes a Deal ID to the linked trade transaction data, and sends the trade transaction data to the matching engine 60 as linked trade transaction data. Control also passes to a block 218 that sends a confirmation of the newly matched trade transaction to both the buyer and the seller. The block 216 also will pass control to a block 220 that matches the trade transaction data based on Deal ID and changes the state of the trade transaction to Trade Linked and then after a suitable period of time to Trade Matched. At this point, the trade transaction data are sent to clearing 64.

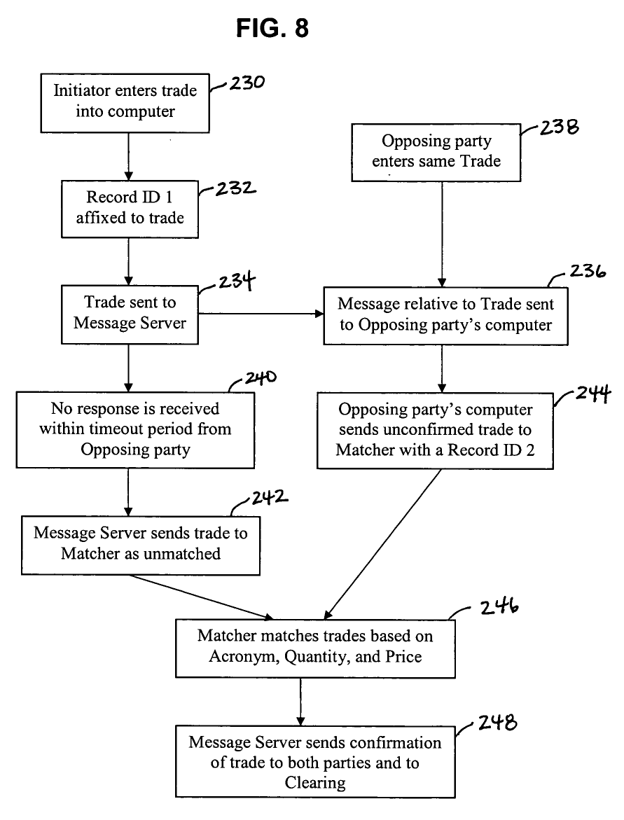

In FIG. 8 an additional embodiment of the invention is shown. A block 230 records the entry of trade transaction data information by an initiator. Control passes to a block 232 that affixes a Record ID to the trade transaction data. Control then passes to a block 234 that sends the trade transaction data to the message server 56. The message server 56 then passes control to a block 236 that sends a message to the designated computer of the opposing party identified by the initiator in the trade transaction data. Previously, a block 238 had recorded the opposing party's entry of trade transaction data relative to the same trade transaction. However, the opposing party did not respond to the message that was generated by the block 236. A block 240 monitors the responses from various users and records that no response was received from the opposing party prior to the expiration of the timeout period. The message server 56 passes control to a block 242 that sends the initiator's trade transaction data to the matching engine 60 as an unmatched trade transaction. After a similar timeout period, a block 244 sends the opposing party's trade transaction data to the matching engine 60 as an unmatched trade transaction with a second Record ID attached to the opposing party's trade transaction data.

After both the seller's trade transaction data and the buyer's trade transaction data are received by the matching engine 60 from blocks 242 and 244, a block 246 attempts to match the above referenced trade transaction data based on various criteria in the matching algorithm of the matching engine 60. In one embodiment of a matching algorithm, the first step in the matching algorithm is to group trade transactions in a hierarchical manner. The hierarchy is contract type, i.e., outright trades, spread trades, and SLEDS trades; then product, i.e., agricultural: corn; then contract type, i.e., futures or options; next for options is the type, i.e., put or call; then the contract date; and lastly the strike price. Using this approach, all outright trades for corn put options for December 2005 at 110 will be grouped for searching and matching. The second step is the actual matching algorithm. Initially the algorithm looks for perfect matches, that is, those trade transaction data where all the key information in two opposing trade transactions match exactly. The first pass in the matching algorithm is a match based on Deal ID. This is the case where the one party accepts a trade transaction initially entered by the opposing party. Here both sides to the trade transaction will have trade transaction data that have a matching Deal ID. The second pass in the algorithm is a match based on firm, acronym, time bracket, and quantity. The third pass is similar to pass two but for block trades. The fourth pass uses a secondary identity of the trading party, sometimes identified as MCR or modified contra reporting, acronym, time bracket and quantity. The fifth pass is similar to the fourth pass but for block trades, and the sixth pass performs a partial trade quantity match to link components of a larger trade transaction on one side to smaller individual trade transactions on the other side. If no match can be made, in certain embodiments, the trade transaction will be held for later matching and if unmatched at the end of the day or after a predetermined period of time, the trade transaction data will be forwarded on to the clearing system 64 matching using the matching algorithms of the clearing system 64. In addition, other suitable matching algorithms or matching schemes can be used.

If the matching engine 60 finds a match based on the intra-day matching algorithm, control will pass back to the message server 56 and a block 248 sends a confirmation message to both parties that the trade transaction has been matched. Because both parties had entered the trade transaction data, even though neither party acknowledged the trade transaction, the matching engine 60 is able to make an intra-day match and alert both parties that the trade transaction has been confirmed.

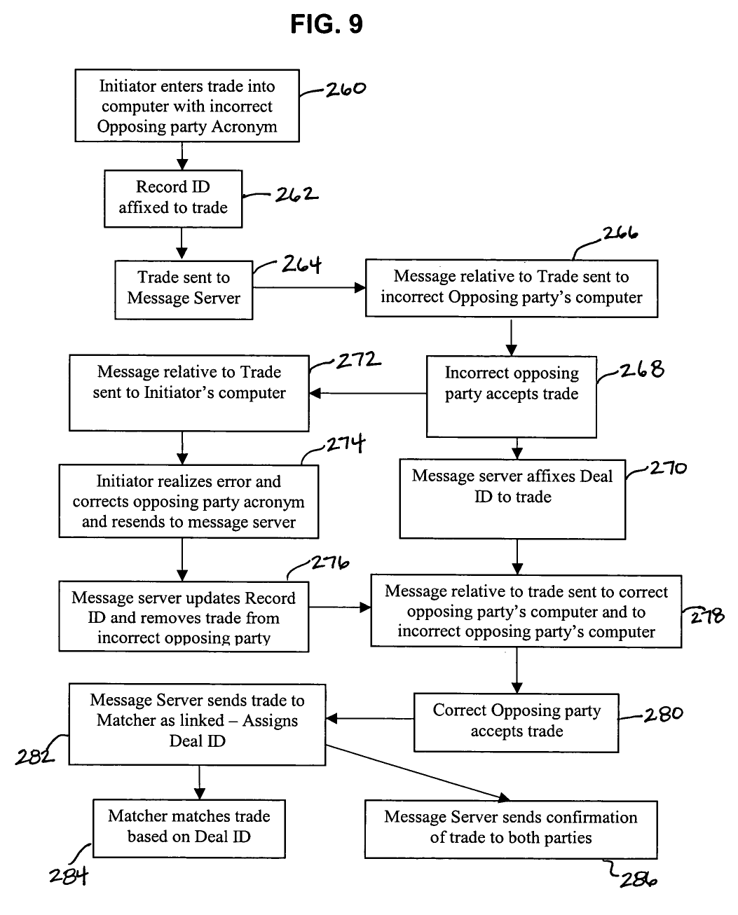

With reference to FIG. 9 that shows the flexibility of one embodiment of the present invention that enables traders to easily correct an error in data entry provided that the error is corrected quickly enough. A block 260 records the trade transaction data that an initiator enters into the initiator's input device, such as the handheld device 54. The data that have been entered by the initiator includes an incorrect identification of an opposing party. Control passes to a block 262 that affixes a Record ID to the trade transaction data. At this point, a block 264 sends the trade transaction data to the message server 56. The message server 56 in a block 266 sends a message to the incorrectly identified opposing party, who mistakenly accepts the trade transaction creating a linked state for that trade transaction. The message server 56 in a block 268 receives an acceptance message from the incorrectly identified party. As discussed previously, the message server 56 in a block 270 affixes a Deal ID to the linked trade transaction data and also at the same time, a block 272 sends a message to the initiator. At this point the state of the trade transaction is Trade Linked. This means that either party can change any of the data of the trade transaction data so long as the trade transaction data remains in the Trade Linked state. In a block 274, the initiator realizes an error in identification has been made and makes a change to the key information relating to the identity of the opposing party. In a similar manner, the opposing party could also recognize that the acceptance of the trade transaction in the block 268 was in error and the opposing party could also cancel the opposing party's acceptance of the trade transaction data. The corrected trade transaction data are sent to the message server 56 and the message server 56 in a block 276 updates the data relative to the Record ID and removes the trade transaction from the Trade Linked state and also removes the trade transaction data from the incorrect opposing party. Control passes to a block 278 that sends a message to the correct opposing party allowing the correct opposing party to link to the trade transaction data. In addition, the block 278 sends a message to the incorrect opposing party indicating that the trade transaction has been canceled. Similar to FIG. 5, the correct opposing party accepts the trade transaction that is recorded in a block 280 by the message server 56. In a block 282, the message server 56 assigns a new Deal ID, sends the linked trade transaction data to the matching engine 60 as linked trade transaction data. In a block 284, the matching engine 60 matches the trade transaction data based on the Deal ID. At roughly the same time, the message server 56 in a block 286 sends a confirmation of the trade transaction to both parties.

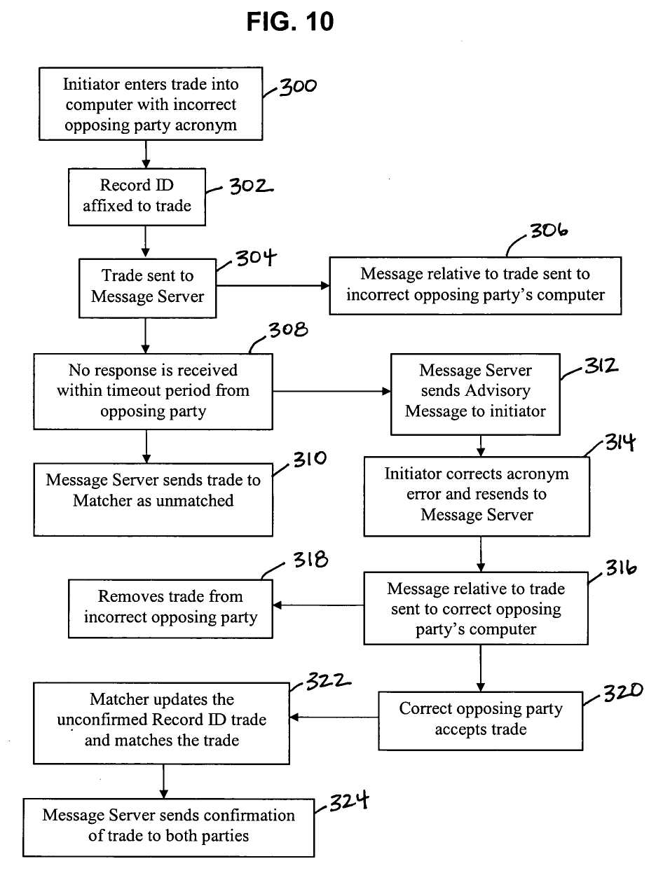

As shown in FIG. 10, an additional embodiment demonstrates a further way that errors made during entry can be corrected, in this case prior to a match or a link. An initiator enters trade transaction data that include an incorrect identification of the opposing trader. One identification system typically used by exchanges assigns each trader and firm a unique acronym. At some exchanges, the acronyms comprise a few letters, while at other exchanges the acronyms can be numbers or a combination of letters and numbers. Many input devices, such as the handheld device 54 can store frequently used acronyms of traders and brokers that are commonly encountered during a trading day. It may be possible that a trader will choose a wrong acronym to identify the opposing trader. A block 300 records the trade transaction data that also happen to include an incorrect identification of the opposing trader. Control passes to a block 302 that affixes a Record ID to the trade transaction data and passes control to a block 304 that sends the trade transaction data to the message server 56. The message server 56 passes control to a block 306 that sends a message to the computer of the incorrectly identified opposing party. In this case, the opposing party ignores the message and does nothing. Because no response is received within the timeout period, the message server 56 will pass control to a block 308 that will pass control to a block 310 that sends the unconfirmed trade transaction data to the matching engine 60 with a Record ID and also to a block 312 that sends an advisory message to the initiator that the trade transaction has not yet been confirmed. At this point, the initiator realizes that an error has been made. Because the trade transaction is unmatched, the state of the trade transaction will be Trade New. This particular state allows either party to make modifications to all aspects of the trade transaction data, including key information, and therefore the initiator is able to correct the trade transaction data to reflect the correct identification of the opposing party. A block 314 records the changes in the trade transaction data and forwards the corrected trade transaction data to the message server 56.

The message server 56 recognizes that the trade transaction data relate to a trade transaction that has a previously affixed Record ID and message server 56 passes control to a block 316 that sends a message to the correct buyer. At the same time, the message server 56 also passes control to a block 318 that removes the incorrect opposing party from the trade transaction data associated with the Record ID and also removes the trade transaction from the incorrect opposing party's computer. The trade transaction data with the incorrectly identified opposing party will also be removed from the matching engine 60. This step will make it less likely that the incorrect opposing party will attempt to link to the incorrect trade transaction data. The system 50 will also correctly identify and deal with a situation where the initiator even before the timeout period has elapsed realizes the error and makes the correction to the opposing party identification. In this case, the message server 56 will immediately send a message on to the correct opposing party and also remove the trade transaction from the incorrect opposing party's computer lessening the opportunity for an incorrect acceptance of the trade transaction.

At this point, the embodiment will operate as before. If the correct opposing party accepts the trade transaction, a block 320 will record this trade transaction data and pass control to a block 322 that sends the trade transaction data to the matching engine 60, and matches the trade transaction data. The message server 56 also will assign a Deal ID to the linked trade transaction data. Control passes back to the message server 56 and a block 324 sends the confirming message out to both correct parties. In the event that the opposing party does not accept within the timeout period but has previously entered correct trade transaction data for the trade transaction, the trade transaction will still be matched as in FIG. 8 based on the intra-day matching algorithm.

If the incorrect opposing party accepts the incorrect trade transaction and if the trade transaction moves from the Trade Linked to the Trade Matched state, then the trade transaction will be considered as matched and neither party will be able to unilaterally change the trade transaction. In this case, the buyer and seller must agree to unmatch the trade transaction outside the system described here. After the trade transaction has been manually removed from the matched state, one party must reenter the trade transaction and indicate that this is a mismatch trade. By doing so, the trade will be properly accounted for in all the volume and other statistics that are maintained and published by exchanges. Once this has been done, the trade transaction can be matched or accepted in the normal course.

### INDUSTRIAL APPLICABILITY

This invention is useful in assisting trade exchanges and/or exchange users to save cost, increase speed and trade transaction processing, and manage risk.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A system for confirming prior to clearing a non-anonymous trade transaction made at an exchange comprising:
a data entry circuit that enables the entry into a computer system of first data relative to the trade transaction on behalf of one party to the trade transaction, wherein the first data includes an identity of the item that is the subject of the trade transaction, a price, a quantity and a code identifying an opposing party to the transaction;
a messaging circuit that sends a message relative to the trade transaction to the opposing party prior to submission of the trade transaction to a matching circuit that matches the trade transaction to second data relative to the trade transaction entered into the system based on identity between certain elements of the first data and the second data; and
a confirmation circuit that sends a message confirming the match to one of the parties.

2. The system of claim 1 wherein the second data are an acceptance of the trade transaction on behalf of the opposing party.

3. The system of claim 2 wherein the acceptance of the trade transaction is automatically made on behalf of the opposing party.

4. The system of claim 2 wherein the acceptance is in multiple parts.

5. The system of claim 1 wherein the data entry circuit also enables the one party to modify the first data provided that the modification is made during a predetermined time period from the time the first data and the second data are linked together.

6. The system of claim 1 that includes an identification circuit that assigns an identification code to the trade transaction.

7. The system of claim 6 wherein the first data and the identification code are sent to the matching circuit as an unconfirmed transaction if there is no response to the checking message within a predetermined period of time.

8. The system of claim 1 wherein the second data are an independent record of the trade transaction made by the opposing party and the matching circuit matches the first data and the second data based on the identity of the one party and the opposing party and the identity between elements of the first data and the second data.

9. The system of claim 1 wherein the second data are an independent record of the trade transaction made by the opposing party.

10. The system of claim 1 wherein the data entry circuit enables one party to correct any error made in the entry of the first data.

11. The system of claim 1 wherein the confirmation circuit sends a confirmation message to both parties.

12. The system of claim 1 wherein the data entry circuit enables one party to correct any error made in the entry of the first data or the second data.

13. The system of claim 1 wherein the first data includes multiple orders.

14. A method for confirming prior to clearing a non-anonymous trade transaction made at an exchange, the method comprising the steps of:
entering into a computer system of first data relative to the trade transaction on behalf of one party to the trade transaction, wherein the first data include an identity of the item that is the subject of the trade transaction, a price, a quantity and a code identifying an opposing party to the transaction;
sending a message relative to the trade transaction to the opposing party;
matching the trade transaction to second data relative to the trade transaction entered into the system based on identity between certain elements of the first data and the second data; and
sending a confirmation of the match to one of the parties.

15. The method of claim 14 wherein the second data are an acceptance of the first data on behalf of the opposing party.

16. The method of claim 14 wherein the second data are linking to data entered on behalf of the opposing party to the first data.

17. The method of claim 16 wherein the linking is done automatically.

18. The method of claim 15 wherein the acceptance is in multiple parts.

19. The method of claim 14 including the step of modifying the first data prior to matching the trade transaction.

20. The method of claim 14 including the step of modifying the first data prior to a predetermined period of time from the time the first data are linked to the second data.

21. The method of claim 14 including the step of sending the first data as an unconfirmed transaction if there is no response to the message within a predetermined period of time.

22. The method of claim 21 wherein the second data are an independent record of the trade transaction made by the opposing party and the matching of the first data and the second data is based on the identity of the one party and the opposing party and the identity between elements of the first data and the second data.

23. The method of claim 14 wherein the second data are an independent record of the trade transaction made by the opposing party.

24. The method of claim 14 wherein a confirmation of the match is sent to both parties.

25. The method of claim 14 including the step of correcting any error made in data entry provided that the correction is made during a predetermined period of time from the time the first data are linked to the second data.

26. The method of claim 14 wherein the first data include multiple orders.
